(19) United States
(12) Patent Application Publication
(10) Pub. No.: US 2021/0362598 A1
(43) Pub. Date: Nov. 25, 2021

(54) INFORMATION DISPLAY METHOD AND SYSTEM USING VEHICLE

(71) Applicant: LG ELECTRONICS INC., Seoul (KR)

(72) Inventor: Jiwon OH, Seoul (KR)

(21) Appl. No.: 16/638,829

(22) PCT Filed: Feb. 15, 2019
(86) PCT No.: PCT/KR2019/001887

§ 371 Date: Feb. 13, 2020

(51) Int. Cl. B60K 35/00; G06F 3/147; G06F 3/14; H04W 4/40; B60W 60/00; B60W 50/14; G09F 9/30; G09F 21/04; G06Q 30/02

(52) U.S. Cl. CPC B60K 35/00; G06F 3/147; G06F 3/1446; H04W 4/40; B60W 60/001; B60W 50/14; B60W 2050/146; G09F 21/049; G06Q 30/0266; G06Q 30/0226; B60K 2370/1529; B60K 2370/178; G09F 9/30

(57) ABSTRACT

Disclosed herein is an information display method and system using a vehicle. In the information display method according to an embodiment of the present invention, vehicle traveling information indicating a location of a vehicle, a posture of the vehicle, and surrounding geographical features is transmitted to an external information providing server. The vehicle supplies the information provided from the information providing server to at least one display with an externally exposed screen to display the information thereon.

### TECHNICAL FIELD

The present invention relates to an information display method and system using a vehicle which can be utilized as an information platform.

### BACKGROUND ART

Vehicles may be classified as internal combustion engine vehicles, external combustion engine vehicles, gas turbine vehicles, electric vehicles, and the like, according to types of prime movers used therein.

Recently, for the safety and convenience of drivers and pedestrians, smart vehicles have been actively developed and research into sensors to be mounted on the intelligent vehicles have actively been conducted. Cameras, infrared sensors, radars, global positioning systems (GPS), lidars, and gyroscopes are used in intelligent vehicles, among which cameras serve to substitute for human eyes.

Due to development of various sensors and electronic equipment, vehicles equipped with a driving assistance function of assisting an occupant in driving and improving driving safety and convenience has come to prominence.

Recently, windows of vehicles are used through a method of displaying a traveling situation information, a traveling state information, and the like on a head-mounted display (HMD) inside vehicles. Meanwhile, the windows of vehicles may be variously utilized outside the vehicles.

### DISCLOSURE

### Technical Problem

An embodiment of the present invention provides an information display method, apparatus and system using a vehicle.

Furthermore, an embodiment of the present invention provides an information display method, apparatus, and system for displaying advertisement content using a window of a vehicle.

Furthermore, an embodiment of the present invention provides a method, apparatus, and system for capable of implementing a new business model by providing advertisement content to a vehicle window.

The technical problems of the present disclosure are not limited to the above-mentioned problems, and other unmentioned problems may be clearly understood by those skilled in the art from the following description.

### Technical Solution

Furthermore, in this specification, an information display method using a vehicle includes: transmitting vehicle traveling information indicating a location of a vehicle, a posture of the vehicle, and surrounding geographical features to an external information providing server; and supplying the information provided from the information providing server to at least one display with an externally exposed screen to display the information on the display, wherein display of a window on which the information is to be displayed is selected from windows of the vehicle on the basis of at least one of a direction in which a screen of the display faces, surrounding geographical features of the vehicle, and visibility of information according to a position of the display.

The information may include at least one of living information, local information, public information, weather, emergency alert, and advertisement information.

The information may be displayed on the window of the vehicle when the vehicle is in a parked or stopped state or when the vehicle is traveling at a low speed lower than a predetermined reference speed.

The information display method may further include: registering the vehicle as a vehicle utilized as an information platform; and setting an information platform activation condition including a specific area where the information is to be displayed, a period during which the information is to be displayed, and a time at which the information is to be displayed, wherein the information is displayed on the window of the vehicle when the information platform activation condition is met.

The information display method may further include: if a current destination of the vehicle is outside the specific area, determining whether to display the advertisement content on the vehicle by determining a possibility of further movement of the vehicle.

The information display method may further include: if the vehicle is not located in the specific area during the period and time set in the information platform activation condition, transmitting, by the information providing server, a movement command instructing to move to the specific area to the vehicle; and allowing the vehicle to move to the specific area in response to the movement command, display the information on the window, and return to an original position thereof of the vehicle.

In response to the movement command, the vehicle may autonomously drive to move to the specific area and subsequently return to an original position thereof.

The information display method may further include: if the movement command is received by the vehicle when the vehicle is in the manual mode, displaying a message indicating to move to the specific area on an internal display of the vehicle.

The information display method may further include: dividing an image of the information into parts and displaying the divided parts on the windows of the vehicle.

The information display method may further include: dividing an image of the information into parts and displaying the divided parts on windows of at least two vehicles.

The information display method may further include: displaying information related to an advertisement product in a magnified manner in an advertisement content image displayed on the window of the vehicle when a person approaches the vehicle, and the information related to the advertisement product includes at least one of detailed information, a URL address, and a QR code of the advertisement product.

The information display method may further include: calculating, by the information providing server, a reward amount or points according to information display history of the vehicle, and an additional service or an article may be purchased at a price discounted as much as the reward amount or a reserved point amount.

Furthermore, in this specification, a vehicle includes: a communication device transmitting vehicle traveling information indicating a location of a vehicle, a posture of the vehicle, and surrounding geographical features to an external information providing server; and an output device supplying the information provided from the information providing server to at least one display with an externally exposed screen through the communication device to display the information on the display, wherein display of a window on which the information is to be displayed is selected from windows of the vehicle on the basis of at least one of a direction in which a screen of the display faces, surrounding geographical features of the vehicle, and visibility of information according to a position of the display.

Furthermore, in this specification, an information display apparatus using a vehicle includes: an information providing server receiving vehicle traveling information indicating a location of a vehicle, a posture of the vehicle, and surrounding geographical features and transmitting the information to the vehicle; and a vehicle control device supplying the information provided from the information providing server to at least one display with an externally exposed screen to display the information on the display, wherein display of a window on which the information is to be displayed is selected from windows of the vehicle on the basis of at least one of a direction in which a screen of the display faces, surrounding geographical features of the vehicle, and visibility of information according to a position of the display.

Furthermore, in this specification, an information display system using a vehicle includes: a vehicle registered as a vehicle consented to utilization as an information platform; and an information providing server receiving vehicle traveling information indicating a location of the vehicle, a posture of the vehicle, and surrounding geographical features from the vehicle and transmitting information to be output on a display disposed on a window of the vehicle to the vehicle, wherein display of a window on which the information is to be displayed is selected from windows of the vehicle on the basis of at least one of a direction in which a screen of the display faces, surrounding geographical features of the vehicle, and visibility of information according to a position of the display.

### Advantageous Effects

Effects of the Information Display Method and System are as Follows.

According to at least one embodiment of the present invention, information (advertisement content) may be displayed on a window of a vehicle in consideration of a location of the vehicle, a posture of the vehicle, and the surrounding geographical features agreed to utilization of an information platform.

According to at least one of the embodiments of the present invention, an effect of exposing information may be maximized by selecting a display of a window in which information is displayed in windows of a vehicle on the basis of at least one of a direction in which a screen of the display disposed in the window of the vehicle faces, a peripheral geographical features of the vehicle, and visibility of information according to locations of the display.

According to at least one of the embodiments of the present invention, information may be displayed on the window of the vehicle when the vehicle is parked or stopped or when the vehicle is traveling at a low speed equal to or lower than a predetermined reference speed in consideration of safety of an occupant of the vehicle or a pedestrian near the vehicle.

According to at least one of the embodiments of the present invention, when a current destination of the vehicle is outside an area set in advance as an information platform utilization area, it is determined whether to display the information on the vehicle by determining whether the vehicle is to be moved further.

According to at least one of the embodiments of the present invention, if the vehicle is not located in a predetermined area during an information platform utilization period and time, the vehicle may be moved to a specific area and information may be displayed on the window of the vehicle.

According to at least one of the embodiments of the present invention, an image of information may be divided to be separately displayed in windows in one vehicle or an image of information may be divided to be separately displayed in windows in two or more vehicles.

According to at least one of the embodiments of the present invention, when a person approaches the vehicle, information related to an advertisement product is enlarged and displayed in an advertisement content image displayed on the window of the vehicle to provide detailed information on the product, detailed purchase information, and the like, to the user, thus enhancing user convenience regarding the product information.

According to at least one of the embodiments of the present invention, a reward amount or points is collected (or earned) according to information display history of the vehicle so that the user may purchase an additional service or an article at a price discounted as much as the reward amount or collected point amount.

### DESCRIPTION OF DRAWINGS

FIG. 1 is a view showing an appearance of a vehicle according to an embodiment of the present invention.

FIG. 2 is a view showing a vehicle according to an embodiment of the present invention from various angles outside a vehicle.

FIGS. 3 and 4 are views showing the inside of a vehicle according to an embodiment of the present invention.

FIGS. 5 and 6 are views showing examples of objects related to traveling of a vehicle according to an embodiment of the present invention.

FIG. 7 is a detailed block diagram of a vehicle according to an embodiment of the present invention.

FIG. 8 is a diagram illustrating an information display system using a vehicle according to an embodiment of the present invention.

FIGS. 9 and 10 are views showing a control procedure of an information display method according to an embodiment of the present invention.

FIG. 11 is a flowchart illustrating a method of selecting a window of a vehicle utilized as an information platform in an information display method according to an embodiment of the present invention.

FIG. 12 is a view showing an example of a method of selecting a display in which information is displayed among displays of a vehicle.

FIGS. 13 and 14 are views showing an example in which an advertisement is displayed on one or more vehicles in a situation where a plurality of vehicles are parked next to each other.

FIG. 15 is a flowchart showing a method of activating an advertisement platform in consideration of a parked/stopped state and a traveling speed of a vehicle.

FIG. 17 is a flowchart illustrating a method of activating an advertisement platform in consideration of a location of a vehicle.

FIGS. 18A to 18C are views showing various examples of information displayed on a window of a vehicle.

FIGS. 19A to 19C are views showing various examples of a method of displaying information displayed on a window of a vehicle when the vehicle operates as an information platform.

FIG. 20 is a view showing a method of controlling an advertisement content image displayed on a window of a vehicle when a person approaches the vehicle operating as an advertisement platform.

FIG. 21 is a flowchart illustrating an example of a method for rewarding for utilization of a vehicle as an advertisement platform.

### MODE FOR INVENTION

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

Further, the present invention is only defined by scopes of claims.

A shape, a size, a ratio, an angle, and a number disclosed in the drawings for describing embodiments of the present invention are merely an example, and thus, the present invention is not limited to the illustrated details. Like reference numerals refer to like elements throughout. In the following description, when the detailed description of the relevant known function or configuration is determined to unnecessarily obscure the important point of the present invention, the detailed description will be omitted.

In a case where ‘comprise’, ‘have’, and ‘include’ described in the present specification are used, another part may be added unless ‘only-’ is used. The terms of a singular form may include plural forms unless referred to the contrary.

In the present disclosure, suffixes such as “module”, “part” or “unit” used for referring to elements are given merely to facilitate explanation of the present invention, without having any significant meaning or role by themselves.

In describing a location relationship, for example, when two portions are described as “connected”, “˜on”, “˜above”, “˜below”, or “˜on the side”, one or more other components may be positioned between the two components unless “immediately” or “directly” is used.

It will be understood that, although the terms “first”, “second”, etc. may be used herein to distinguish between various elements, these elements should not be limited by the ordinal number of the components or the name of the components in function or structure.

In the description, the singular forms “a”, “an” and “the” are intended to include the plural forms as well, unless the context clearly indicates otherwise.

The vehicle described in this disclosure may include an internal combustion engine vehicle having an engine as a power source, a hybrid vehicle having an engine and an electric motor as a power source and an electric vehicle having an electric motor as a power source. Hereinafter, an embodiment of an autonomous driving vehicle will be mainly described but the vehicle of the present invention is not limited thereto. For example, any vehicle having a display device connected to an information provider server via a communication network and externally displaying information may be applied to the present invention.

The following embodiments of the present invention may be partially or overall coupled to or combined with each other, and may be variously inter-operated with each other and driven technically as those skilled in the art may sufficiently understand. The embodiments of the present invention may be carried out independently from each other, or may be carried out together in co-dependent relationship.

Hereinafter, various embodiments of the present disclosure will be described in detail with reference to the accompanying drawings.

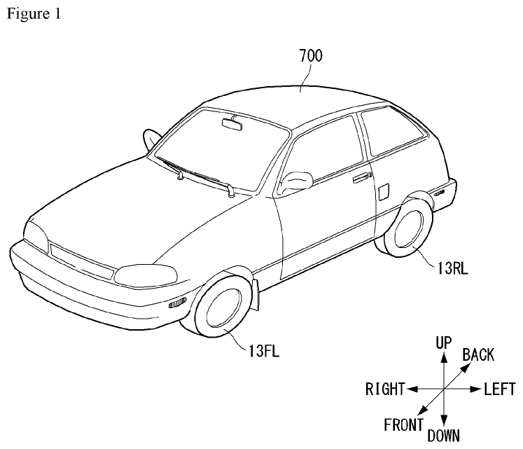

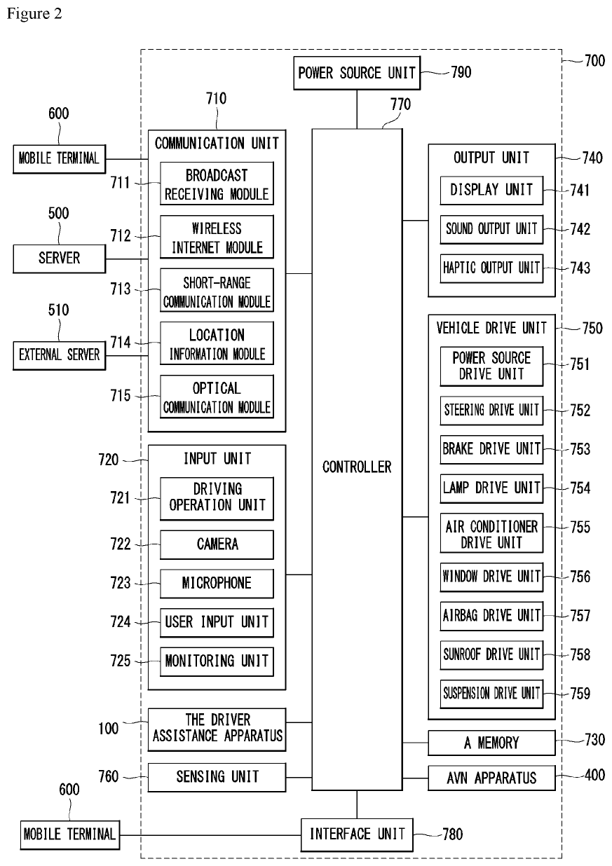

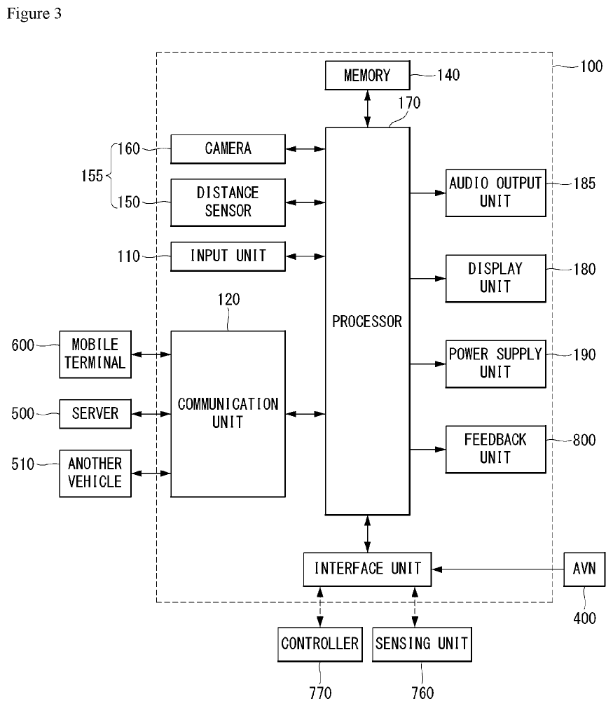

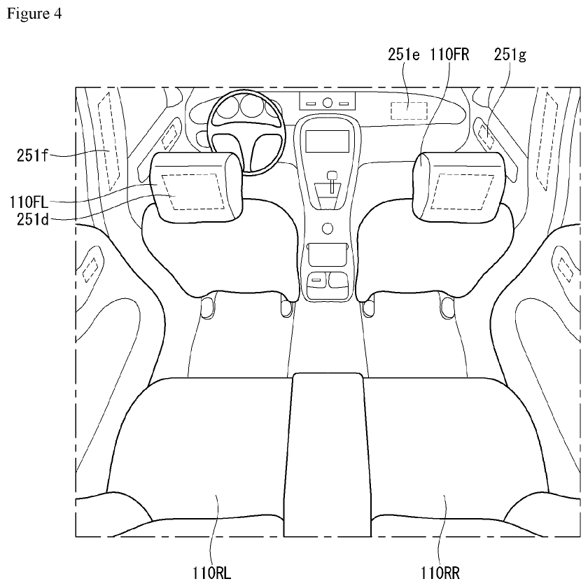

Referring to FIGS. 1 to 7, a vehicle 100 may include a wheel rotated by a power source and a steering input device 510 for adjusting a movement direction of the vehicle 100.

The vehicle 100 may be remotely controlled by an external device. The external device may be a server, a mobile terminal, another vehicle, or the like. The server may perform remote control on the vehicle 100 when the vehicle 100 is determined to be remotely controlled. An information provider server may transmit various information to the vehicle 100.

Information is displayed as visual information such as a graphic image, text, and the like, reproduced in a display device of the vehicle 100. The information may include various information such as living information, local information, public information, weather, emergency alert, advertisement information, and the like.

The vehicle 100 may operate in a manual mode, an autonomous driving mode, or a remote control mode. The manual mode may be a mode indicating a subject for controlling the vehicle 100. In the autonomous driving mode, the controller 170 or an operating system 700 directly controls the vehicle 100 without driver intervention and operates the vehicle 100 toward a destination set by the driver. In the remote control mode, an external device controls the vehicle 100 without driver intervention.

A user may select one of the autonomous driving mode, the manual mode, and the remote control mode through a user interface device 200.

The vehicle 100 may be automatically switched to one of the autonomous driving mode, the manual mode, and the remote control mode on the basis of at least one of driver state information, vehicle traveling information, and vehicle state information.

The driver state information may be generated through the user interface device 200 and provided to the controller 170. The driver state information may be generated on the basis of an image or biometric information of the driver detected through an internal camera 220 or a biometric sensing unit 230. For example, the driver state information may include a gaze, facial expression, behavior, and driver location information of the driver acquired from the image acquired through the internal camera 220. The driver state information may include biometric information of the user acquired through the biometric sensing unit 230. The driver state information may indicate a direction the gate of the driver, sleepiness of the driver, a health state of the driver, an emotional state of the driver, and the like.

The vehicle traveling information may be generated on the basis of object information provided by the object detection device 300 or information received through the communication device 400. The vehicle traveling information may include location information of the vehicle 100, posture information of the vehicle 100, information on another vehicle OB11 received from the other vehicle OB11, information on a traveling route of the vehicle 100, navigation information including a map, and the like.

The vehicle traveling information indicates a kind, location, and movement of an object present near the vehicle 100, presence or absence of a lane detected near the vehicle 100, and the like. In addition, the vehicle traveling information may include traveling information of the other vehicle 100, a lay-by (a space for drivers to stop) near the vehicle 100, a possibility of collision between the vehicle and an object, pedestrian or bicycle information detected near the vehicle 100, a signal state near the vehicle 100, a movement of the vehicle 100, and the like.

The vehicle traveling information may be generated by linking at least one of the object detection device 300, the communication device 400, the navigation system 770, the sensing unit 120, and the interface unit 130, and provided to the controller 170.

The vehicle state information may be information related to states of various devices provided in the vehicle 100. For example, the vehicle state information includes information on a charged state of a battery, information on an operational state of the user interface device 200, the object detection device 300, the communication device 400, a maneuvering device 500, a vehicle drive device 600, an operation system 700, and information on whether each device is abnormal.

The vehicle state information may indicate whether a GPS signal of the vehicle 100 is normally received, whether at least one of the sensors provided in the vehicle 100 is abnormal, and whether each of the devices provided in the vehicle 100 normally operates.

On the basis of the object information generated by the object detection device 300, a control mode of the vehicle 100 may be switched from the manual mode to the autonomous driving mode or may be switched from the autonomous driving mode to the manual mode.

The control mode of the vehicle 100 may be switched from the manual mode to the autonomous driving mode or switched from the autonomous driving mode to the manual mode on the basis of the information received through the communication device 400.

The control mode of the vehicle 100 may be switched from the manual mode to the autonomous driving mode or from the autonomous driving mode to the manual mode on the basis of the information, data, and signals provided by the external device.

When the vehicle 100 is operated in the autonomous driving mode, the vehicle 100 may be operated under the control of the operation system 700. In the autonomous driving mode, the vehicle 100 may be operated on the basis of information generated in a driving system 710, a vehicle pulling-out system 740, and a vehicle parking system 750.

When the vehicle 100 is operated in the manual mode, the vehicle 100 may receive a user input for driving through the maneuvering device 500. The vehicle 100 may be operated on the basis of a user input received through the maneuvering device 500.

When the vehicle 100 is operated in the remote control mode, the vehicle 100 may receive a remote control signal transmitted from the external device through the communication device 400. The vehicle 100 may be controlled on the basis of the remote control signal.

In the description below, the overall length of the vehicle 100 refers to a length from the front end to the rear end of the vehicle 100, the overall width of the vehicle 100 refers to the width of the vehicle 100, and the overall height of the vehicle 100 refers to the height from the bottom of the wheel to the roof of the vehicle 100. In FIG. 1, the overall length direction L may refer to a reference direction for the measurement of the overall length of the vehicle 100, the overall width direction W may refer to a reference direction for the measurement of the overall width of the vehicle 100, and the overall height direction H may refer to a reference direction for the measurement of the overall height of the vehicle 100.

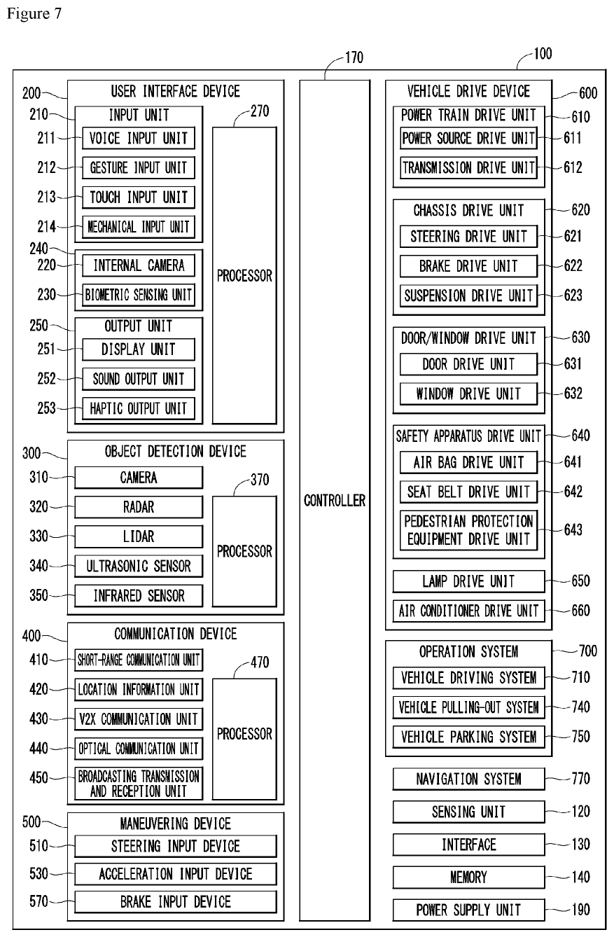

As illustrated in FIG. 7, the vehicle 100 may include the user interface device 200, the object detection device 300, the communication device 400, the maneuvering device 500, a vehicle drive device 600, the operation system 700, a navigation system 770, a sensing unit 120, an interface 130, a memory 140, a controller 170, and a power supply unit 190.

Components other than the components shown in FIG. 7 may be further included, or some components may be omitted.

The user interface device 200 is provided to support communication between the vehicle 100 and a user. The user interface device 200 may receive a user input, and provide information generated in the vehicle 100 to the user. The vehicle 100 may enable User Interfaces (UI) or User Experience (UX) through the user interface device 200.

The user interface device 200 may include an input unit 210, an internal camera 220, a biometric sensing unit 230, an output unit 250, and a processor 270.

The input unit 210 is configured to receive a user command from a user, and data collected in the input unit 210 may be analyzed by the processor 270 and then recognized as a control command of the user.

The input unit 210 may be disposed inside the vehicle 100. For example, the input unit 210 may be disposed in a region of a steering wheel, a region of an instrument panel, a region of a seat, a region of each pillar, a region of a door, a region of a center console, a region of a head lining, a region of a sun visor, a region of a windshield, or a region of a window.

The input unit 210 may include a voice input unit 211, a gesture input unit 212, a touch input unit 213, and a mechanical input unit 214.

The voice input unit 211 may convert a voice input of a user into an electrical signal. The converted electrical signal may be provided to the processor 270 or the controller 170. The voice input unit 211 may include one or more microphones.

The gesture input unit 212 may convert a gesture input of a user into an electrical signal. The converted electrical signal may be provided to the processor 270 or the controller 170. The gesture input unit 212 may include at least one selected from among an infrared sensor and an image sensor for sensing a gesture input of a user.

In some implementations, the gesture input unit 212 may sense a three-dimensional (3D) gesture input of a user. To this end, the gesture input unit 212 may include a plurality of light emitting units for outputting infrared light, or a plurality of image sensors.

The gesture input unit 212 may sense the 3D gesture input by employing a Time of Flight (TOF) scheme, a structured light scheme, or a disparity scheme.

The touch input unit 213 may convert a user's touch input into an electrical signal. The converted electrical signal may be provided to the processor 270 or the controller 170. The touch input unit 213 may include a touch sensor for sensing a touch input of a user. In some implementations, the touch input unit 210 may be formed integral with a display unit 251 to implement a touch screen. The touch screen may provide an input interface and an output interface between the vehicle 100 and the user.

The mechanical input unit 214 may include at least one selected from among a button, a dome switch, a jog wheel, and a jog switch. An electrical signal generated by the mechanical input unit 214 may be provided to the processor 270 or the controller 170. The mechanical input unit 214 may be located on a steering wheel, a center fascia, a center console, a cockpit module, a door, etc.

An occupant sensing unit 240 may detect an occupant in the vehicle 100. The occupant sensing unit 240 may include the internal camera 220 and the biometric sensing unit 230.

The internal camera 220 may acquire images of the inside of the vehicle 100. The processor 270 may sense a user's state on the basis of the images of the inside of the vehicle 100. For example, a user's detected condition may be about an eye gaze, a face, a behavior, a facial expression, and a location of the user.

The processor 270 may acquire information on the eye gaze, the face, the behavior, the facial expression, and the location of the user from an image of the inside of the vehicle 100. The processor 270 may sense a gesture of the user from the image of the inside of the vehicle 100. The information acquired by the processor 270 from the image of the inside of the vehicle 100 may be driver state information. In this case, the driver state information may indicate a direction in which a gaze of the driver is directed, and a behavior, facial expression, and gesture of the driver. The processor 270 may provide the driver state information, which is acquired from the image of the inside of the vehicle 100, to the controller 170.

The biometric sensing unit 230 may acquire biometric information of the user. The biometric sensing unit 230 may include a sensor for acquire biometric information of the user, and may utilize the sensor to acquire finger print information, heart rate information, brain wave information etc. Of the user. The biometric information may be used to authenticate a user or determine the user's condition.

The processor 270 may determine a driver's state on the basis of the driver's biometric information. Information acquired by the processor 270 through determining the driver's condition may be driver state information. In this case, the driver state information may indicate whether the driver is in faint, dozing off, excited, or in an emergency situation. The processor 270 may provide the driver state information, acquired on the basis of the driver's biometric information, to the controller 170.

The output unit 250 is configured to generate a visual, audio, or tactile output. The output unit 250 may include at least one selected from among a display unit 251, a sound output unit 252, and a haptic output unit 253.

The display unit 251 may display graphic objects corresponding to various types of information. The display unit 251 may include at least one selected from among a Liquid Crystal Display (LCD), a Thin Film Transistor-Liquid Crystal Display (TFT LCD), an Organic Light-Emitting Diode (OLED), a flexible display, a 3D display, and an e-ink display.

The display unit 251 may form an inter-layer structure together with the touch input unit 213, or may be integrally formed with the touch input unit 213 to implement a touch screen.

The display unit 251 may be implemented as a Head Up Display (HUD). When implemented as a HUD, the display unit 251 may include a projector module in order to output information through an image projected on a windshield or a window.

The display unit 251 may include a transparent display. The transparent display may be attached on the windshield or the window. The transparent display may display a predetermined screen with a predetermined transparency. In order to achieve the transparency, the transparent display may include at least one selected from among a transparent Thin Film Electroluminescent (TFEL) display, an Organic Light Emitting Diode (OLED) display, a transparent Liquid Crystal Display (LCD), a transmissive transparent display, and a transparent Light Emitting Diode (LED) display. The transparency of the transparent display may be adjustable.

In some implementations, the user interface device 200 may include a plurality of display units 251a to 251g. The display unit 251 may be disposed in a region 251a of a steering wheel, a region 251b or 251e of an instrument panel, a region 251d of a seat, a region 251f of each pillar, a region 251g of a door, a region of a center console, a region of a head lining, a region of a sun visor, a region 251c of a windshield, or a region 251h of a window.

The sound output unit 252 converts an electrical signal from the processor 270 or the controller 170 into an audio signal, and outputs the audio signal. To this end, the sound output unit 252 may include one or more speakers.

The haptic output unit 253 generates a tactile output. For example, the haptic output unit 253 may operate to vibrate a steering wheel, a safety belt, and seats 110FL, 110FR, 110RL, and 110RR so as to allow a user to recognize the output.

The processor 270 may control the overall operation of each unit of the user interface device 200. In a case where the user interface device 200 does not include the processor 270, the user interface device 200 may operate under control of the controller 170 or a processor of a different device inside the vehicle 100.

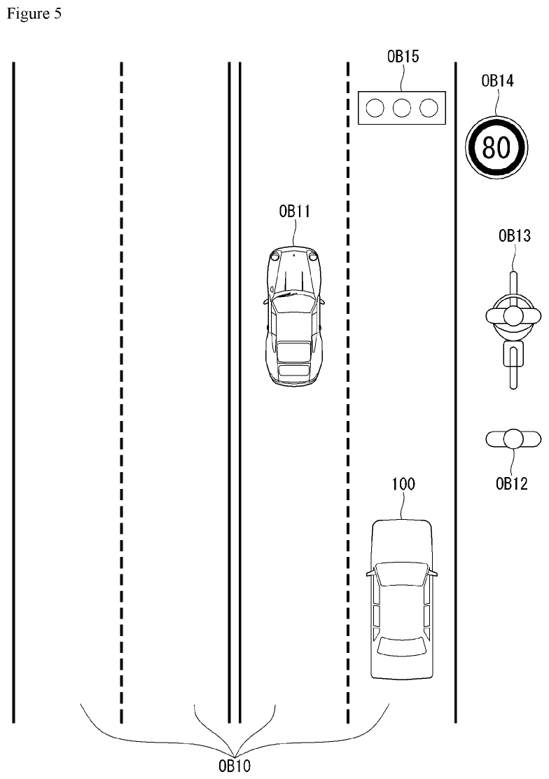

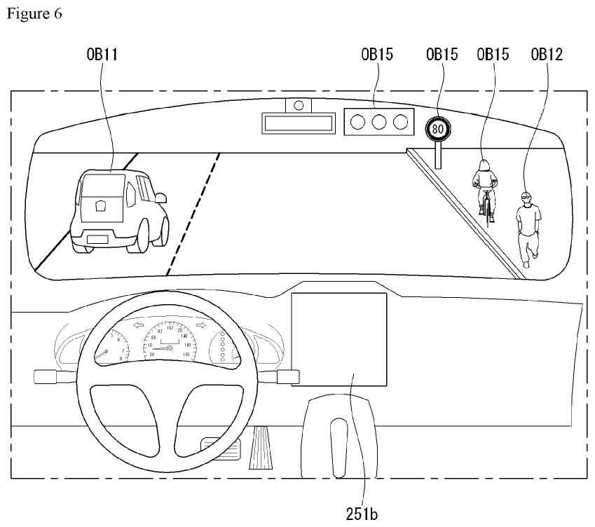

The object detection device 300 is configured to detect an object outside the vehicle 100. The object may include various objects related to travelling of the vehicle 100. Referring to FIGS. 5 and 6, an object o may include a lane OB10, a nearby vehicle OB11, a pedestrian OB12, a two-wheeled vehicle OB13, a traffic sign OB14 and OB15, a light, a road, a structure, a bump, a geographical feature, an animal, etc.

The lane OB10 may be a lane in which the vehicle 100 is traveling, a lane next to the lane in which the vehicle 100 is traveling, or a lane in which a different vehicle is travelling from the opposite direction. The lane OB10 may include left and right lines that define the lane.

The nearby vehicle OB11 may be a vehicle that is travelling in the vicinity of the vehicle 100. The nearby vehicle OBI 1 may be a vehicle within a predetermined distance from the vehicle 100. For example, the nearby vehicle OB11 may be a vehicle that is travelling ahead or behind the vehicle 100.

The pedestrian OB12 may be a person in the vicinity of the vehicle 100. The pedestrian OB12 may be a person within a predetermined distance from the vehicle 100. For example, the pedestrian OB12 may be a person on a sidewalk or on the roadway.

The two-wheeled vehicle OB13 is a vehicle that is located in the vicinity of the vehicle 100 and moves with two wheels. The two-wheeled vehicle OB13 may be a vehicle that has two wheels within a predetermined distance from the vehicle 100. For example, the two-wheeled vehicle OB13 may be a motorcycle or a bike on a sidewalk or the roadway.

The traffic sign may include a traffic light OB15, a traffic sign plate OB14, and a pattern or text painted on a road surface.

The light may be light generated by a lamp provided in the nearby vehicle. The light may be light generated by a street light. The light may be solar light.

The road may include a road surface, a curve, and slopes, such as an upward slope and a downward slope.

The structure may be a body located around the road in the state of being fixed onto the ground. For example, the structure may include a streetlight, a roadside tree, a building, a bridge, a traffic light, a curb, a guardrail, etc.

The geographical feature may include a mountain and a hill.

In some implementations, the object may be classified as a movable object or a stationary object. For example, the movable object may include a nearby vehicle and a pedestrian. For example, the stationary object may include a traffic sign, a road, a structure, and a traffic line.

The object detection device 300 may include a camera 310, a radar 320, a lidar 330, an ultrasonic sensor 340, an infrared sensor 350, and a processor 370.

The camera 310 may be located at an appropriate location outside the vehicle 100 in order to acquire images of the outside of the vehicle 100. The camera 310 may be a mono camera, a stereo camera 310a, an Around View Monitoring (AVM) camera 310b, or a 360-degree camera.

For example, the camera 310 may be disposed near a front windshield in the vehicle 100 in order to acquire images of the front of the vehicle 100. Alternatively, the camera 310 may be disposed around a front bumper or a radiator grill. In another example, the camera 310 may be disposed near a rear glass in the vehicle 100 in order to acquire images of the rear of the vehicle 100. Alternatively, the camera 310 may be disposed around a rear bumper, a trunk, or a tailgate. In yet another example, the camera 310 may be disposed near at least one of the side windows in the vehicle 100 in order to acquire images of the side of the vehicle 100. Alternatively, the camera 310 may be disposed around a side mirror, a fender, or a door. The camera 310 may provide an acquired image to the processor 370.

The radar 320 may include an electromagnetic wave transmission unit and an electromagnetic wave reception unit. The radar 320 may be realized as a pulse radar or a continuous wave radar depending on the principle of emission of an electronic wave. In addition, the radar 320 may be realized as a Frequency Modulated Continuous Wave (FMCW) type radar or a Frequency Shift Keying (FSK) type radar depending on the waveform of a signal.

The radar 320 may detect an object through the medium of an electromagnetic wave by employing a time of flight (TOF) scheme or a phase-shift scheme, and may detect a location of the detected object, the distance to the detected object, and the speed relative to the detected object.

The radar 320 may be located at an appropriate location outside the vehicle 100 in order to sense an object located in front of the vehicle 100, an object located to the rear of the vehicle 100, or an object located to the side of the vehicle 100.

The lidar 330 may include a laser transmission unit and a laser reception unit. The lidar 330 may be implemented by the TOF scheme or the phase-shift scheme. The lidar 330 may be implemented as a drive type lidar or a non-drive type lidar. When implemented as the drive type lidar, the lidar 300 may rotate by a motor and detect an object in the vicinity of the vehicle 100. When implemented as the non-drive type lidar, the lidar 300 may utilize a light steering technique to detect an object located within a predetermined distance from the vehicle 100.

The lidar 330 may detect an object through the medium of laser light by employing the TOF scheme or the phase-shift scheme, and may detect a location of the detected object, the distance to the detected object, and the speed relative to the detected object.

The lidar 330 may be located at an appropriate location outside the vehicle 100 in order to sense an object located in front of the vehicle 100, an object located to the rear of the vehicle 100, or an object located to the side of the vehicle 100.

The ultrasonic sensor 340 may include an ultrasonic wave transmission unit and an ultrasonic wave reception unit. The ultrasonic sensor 340 may detect an object on the basis of an ultrasonic wave, and may detect a location of the detected object, the distance to the detected object, and the speed relative to the detected object.

The ultrasonic sensor 340 may be located at an appropriate location outside the vehicle 100 in order to detect an object located in front of the vehicle 100, an object located to the rear of the vehicle 100, and an object located to the side of the vehicle 100.

The infrared sensor 350 may include an infrared light transmission unit and an infrared light reception unit. The infrared sensor 340 may detect an object on the basis of infrared light, and may detect a location of the detected object, the distance to the detected object, and the speed relative to the detected object.

The infrared sensor 350 may be located at an appropriate location outside the vehicle 100 in order to sense an object located in front of the vehicle 100, an object located to the rear of the vehicle 100, or an object located to the side of the vehicle 100.

The processor 370 may control the overall operation of each unit of the object detection device 300. The processor 370 may detect and track an object on the basis of acquired images. The processor 370 may, for example, calculate the distance to the object and the speed relative to the object, determine a type, location, size, shape, color, moving path of the object, and determine a detected text.

The processor 370 may detect and track an object on the basis of a reflection electromagnetic wave which is formed as a result of reflection a transmission electromagnetic wave by the object. On the basis of the electromagnetic wave, the processor 370 may, for example, calculate the distance to the object and the speed relative to the object.

The processor 370 may detect and track an object on the basis of a reflection laser light which is formed as a result of reflection of transmission laser by the object. On the basis of the laser light, the processor 370 may, for example, calculate the distance to the object and the speed relative to the object.

The processor 370 may detect and track an object on the basis of a reflection ultrasonic wave which is formed as a result of reflection of a transmission ultrasonic wave by the object. On the basis of the ultrasonic wave, the processor 370 may, for example, calculate the distance to the object and the speed relative to the object.

The processor 370 may detect and track an object on the basis of reflection infrared light which is formed as a result of reflection of transmission infrared light by the object. On the basis of the infrared light, the processor 370 may, for example, calculate the distance to the object and the speed relative to the object.

The processor may generate object information on the basis of at least one of the following: an information acquired using the camera 310, a reflected electronic wave received using the radar 320, a reflected laser light received using the lidar 330, and a reflected ultrasonic wave received using the ultrasonic sensor 340, and a reflected infrared light received using the infrared sensor 350.

The object information may be information about a type, location, size, shape, color, a moving path, and speed of an object existing around the vehicle 100 and information about a detected text. For example, the object information may indicate: whether a traffic line exists in the vicinity of the vehicle 100; whether any nearby vehicle is travelling while the vehicle 100 is stopped; whether there is a space in the vicinity of the vehicle 100 to stop; whether a vehicle and an object could collide; where a pedestrian or a bicycle is located with reference to the vehicle 100; a type of a roadway in which the vehicle 100 is travelling, a status of a traffic light in the vicinity of the vehicle 100, and movement of the vehicle 100.

In some implementations, the object detection device 300 may include a plurality of processors 370 or may not include the processor 370. For example, each of the camera 310, the radar 320, the lidar 330, the ultrasonic sensor 340, and the infrared sensor 350 may include its own processor.

The object detection device 300 may operate under control of the controller 170 or a processor inside the vehicle 100.

The communication device 400 is configured to perform communication with an external device. Here, the external device may be a nearby vehicle, a mobile terminal, or a server. To perform communication, the communication device 400 may include at least one selected from among a transmission antenna, a reception antenna, a Radio Frequency (RF) circuit capable of implementing various communication protocols, and an RF device.

The communication device 400 may include a short-range communication unit 410, a location information unit 420, a V2X communication unit 430, an optical communication unit 440, a broadcast transmission and reception unit 450, and a processor 470.

The short-range communication unit 410 is configured to perform short-range communication. The short-range communication unit 410 may support short-range communication using at least one selected from among Bluetooth •, Radio Frequency IDdentification (RFID), Infrared Data Association (IrDA), Ultra-WideBand (UWB), ZigBee, Near Field Communication (NFC), Wireless-Fidelity (Wi-Fi), Wi-Fi Direct, and Wireless USB (Wireless Universal Serial Bus).

The short-range communication unit 410 may form wireless area networks to perform short-range communication between the vehicle 100 and at least one external device.

The location information unit 420 is configured to acquire location information of the vehicle 100. For example, the location information unit 420 may include at least one of a Global Positioning System (GPS) module, a Differential Global Positioning System (DGPS) module, and a Carrier phase Differential GPS (CDGPS) module.

The V2X communication unit 430 is configured to perform wireless communication between a vehicle and a server (that is, vehicle to infra (V2I) communication), wireless communication between a vehicle and a nearby vehicle (that is, vehicle to vehicle (V2V) communication), or wireless communication between a vehicle and a pedestrian (that is, vehicle to pedestrian (V2P) communication).

The optical communication unit 440 is configured to perform communication with an external device through the medium of light. The optical communication unit 440 may include a light emitting unit, which converts an electrical signal into an optical signal and transmits the optical signal to the outside, and a light receiving unit which converts a received optical signal into an electrical signal. In some implementations, the light emitting unit may be integrally formed with a lamp provided included in the vehicle 100.

The broadcast transmission and reception unit 450 is configured to receive a broadcast signal from an external broadcasting management server or transmit a broadcast signal to the broadcasting management server through a broadcasting channel. The broadcasting channel may include a satellite channel, and a terrestrial channel. The broadcast signal may include a TV broadcast signal, a radio broadcast signal, and a data broadcast signal.

The processor 470 may control the overall operation of each unit of the communication device 400. Vehicle traveling information may include information that is received using at least one of the short-range communication unit 410, the location information unit 420, the V2X communication unit 430, the optical communication unit 440, and the broadcast transmission and reception unit 450. For example, the vehicle traveling information may include information about a location, a type, a travel path, a speed, and a variety of sensing values of a different vehicle, the information which is received from the different vehicle. If information on a variety of sensing information of the different vehicle is received using the communication device 400, the controller 170 may acquire information on various objects existing around the vehicle 100, even though the vehicle 100 does not have an additional sensor.

In a case where the communication device 400 does not include the processor 470, the communication device 400 may operate under control of the controller 170 or a processor of a device inside of the vehicle 100.

In some implementations, the communication device 400 may implement a vehicle display device, together with the user interface device 200. In this case, the vehicle display device may be referred to as a telematics device or an Audio Video Navigation (AVN) device.

The controller 170 may transmit at least one of driver state information, vehicle state information, vehicle traveling information, error information indicating an error of the vehicle 100, object information, a user input received through the user interface device 200, and a remote control request signal to an external device on the basis of a signal received from the communication device 400. A remote controlling server may determine whether remote controlling is required for the vehicle 100 on the basis of information transmitted from the vehicle 100.

The controller 170 may control the vehicle 100 according to a control signal received from the remote controlling server.

The maneuvering device 500 is configured to receive a user command for driving the vehicle 100. In the manual driving mode, the vehicle 100 may operate on the basis of a signal provided by the maneuvering device 500.

The maneuvering device 500 may include a steering input device 510, an acceleration input device 530, and a brake input device 570.

The steering input device 510 may receive a user command for steering of the vehicle 100. The steering input device 510 may take the form of a wheel to enable a steering input through the rotation thereof. In some implementations, the steering input device may be provided as a touchscreen, a touch pad, or a button.

The acceleration input device 530 may receive a user command for acceleration of the vehicle 100. The brake input device 570 may receive a user command for deceleration of the vehicle 100. Each of the acceleration input device 530 and the brake input device 570 may take the form of a pedal. In some implementations, the acceleration input device or the break input device may be configured as a touch screen, a touch pad, or a button.

The maneuvering device 500 may operate under control of the controller 170.

The vehicle drive device 600 is configured to electrically control the operation of various devices of the vehicle 100. The vehicle drive device 600 may include a power train drive unit 610, a chassis drive unit 620, a door/window drive unit 630, a safety apparatus drive unit 640, a lamp drive unit 650, and an air conditioner drive unit 660.

The power train drive unit 610 may control the operation of a power train. The power train drive unit 610 may include a power source drive unit 611 and a transmission drive unit 612.

The power source drive unit 611 may control a power source of the vehicle 100. In the case in which a fossil fuel-based engine is the power source, the power source drive unit 611 may perform electronic control of the engine. As such the power source drive unit 611 may control, for example, the output torque of the engine. The power source drive unit 611 may adjust the output toque of the engine under control of the controller 170. In a case where an electric motor is the power source, the power source drive unit 611 may control the motor. The power source drive unit 610 may control, for example, the RPM and toque of the motor under control of the controller 170.

The transmission drive unit 612 may control a transmission. The transmission drive unit 612 may adjust the state of the transmission. The transmission drive unit 612 may adjust a state of the transmission to a drive (D), reverse (R), neutral (N), or park (P) state. In some implementations, in a case where an engine is the power source, the transmission drive unit 612 may adjust a gear-engaged state to the drive location D.

The chassis drive unit 620 may control the operation of a chassis. The chassis drive unit 620 may include a steering drive unit 621, a brake drive unit 622, and a suspension drive unit 623.

The steering drive unit 621 may perform electronic control of a steering apparatus provided inside the vehicle 100. The steering drive unit 621 may change the direction of travel of the vehicle 100.

The brake drive unit 622 may perform electronic control of a brake apparatus provided inside the vehicle 100. For example, the brake drive unit 622 may reduce the speed of the vehicle 100 by controlling the operation of a brake located at a wheel. In some implementations, the brake drive unit 622 may control a plurality of brakes individually. The brake drive unit 622 may apply a different degree-braking force to each wheel.

The suspension drive unit 623 may perform electronic control of a suspension apparatus inside the vehicle 100. For example, when the road surface is uneven, the suspension drive unit 623 may control the suspension apparatus so as to reduce the vibration of the vehicle 100. In some implementations, the suspension drive unit 623 may control a plurality of suspensions individually.

The door/window drive unit 630 may perform electronic control of a door device or a window device inside the vehicle 100. The door/window drive unit 630 may include a door drive unit 631 and a window drive unit 632. The door drive unit 631 may control the door device. The door drive unit 631 may control opening or closing of a plurality of doors included in the vehicle 100. The door drive unit 631 may control opening or closing of a trunk or a tail gate. The door drive unit 631 may control opening or closing of a sunroof.

The window drive unit 632 may perform electronic control of the window device. The window drive unit 632 may control opening or closing of a plurality of windows included in the vehicle 100.

The safety apparatus drive unit 640 may perform electronic control of various safety apparatuses provided inside the vehicle 100. The safety apparatus drive unit 640 may include an airbag drive unit 641, a safety belt drive unit 642, and a pedestrian protection equipment drive unit 643.

The airbag drive unit 641 may perform electronic control of an airbag apparatus inside the vehicle 100. For example, upon detection of a dangerous situation, the airbag drive unit 641 may control an airbag to be deployed.

The safety belt drive unit 642 may perform electronic control of a seatbelt apparatus inside the vehicle 100. For example, upon detection of a dangerous situation, the safety belt drive unit 642 may control passengers to be fixed onto seats 110FL, 110FR, 110RL, and 110RR with safety belts.

The pedestrian protection equipment drive unit 643 may perform electronic control of a hood lift and a pedestrian airbag. For example, upon detection of a collision with a pedestrian, the pedestrian protection equipment drive unit 643 may control a hood lift and a pedestrian airbag to be deployed.

The lamp drive unit 650 may perform electronic control of various lamp apparatuses provided inside the vehicle 100.

The air conditioner drive unit 660 may perform electronic control of an air conditioner inside the vehicle 100.

The operation system 700 is a system for controlling the overall operation of the vehicle 100. The operation system 700 may operate in an autonomous driving mode.

The operation system 700 may include the driving system 710, the vehicle pulling-out system 740, and the vehicle parking system 750.

In some implementations, in a case where the operation system 700 is implemented as software, the operation system 700 may be a subordinate concept of the controller 170.

In some implementations, in some implementations, the operation system 700 may be a concept including at least one selected from among the user interface device 200, the object detection device 300, the communication device 400, the vehicle drive device 600, and the controller 170.

The driving system 710 may perform driving of the vehicle 100. The driving system 710 may perform driving of the vehicle 100 by providing a control signal to the vehicle drive device 600 in response to reception of navigation information from the navigation system 770. The driving system 710 may perform driving of the vehicle 100 by providing a control signal to the vehicle drive device 600 in response to reception of object information from the object detection device 300. The driving system 710 may perform driving of the vehicle 100 by providing a control signal to the vehicle drive device 600 in response to reception of a signal from an external device through the communication device 400.

The parking-out system 740 may park the vehicle 100 out of a parking space. The parking-out system 740 may park the vehicle 100 out of a parking space, by providing a control signal to the vehicle drive device 600 on the basis of location information of the vehicle 100 and navigation information provided by the navigation system 770. The parking-out system 740 may park the vehicle 100 out of a parking space, by providing a control signal to the vehicle drive device 600 on the basis of object information provided by the object detection device 300. The parking-out system 740 may park the vehicle 100 out of a parking space, by providing a control signal to the vehicle drive device 600 on the basis of a signal provided by an external device.

The parking system 750 may park the vehicle 100 in a parking space. The vehicle parking system 750 may perform an operation of parking the vehicle 100 in a parking space, by providing a control signal to the vehicle drive device 600 on the basis of location information of the vehicle 100 and navigation information provided by the navigation system 770. The parking system 750 may park the vehicle 100 in a parking space, by providing a control signal to the vehicle drive device 600 on the basis of object information provided by the object detection device 300. The parking system 750 may park the vehicle 100 in a parking space, by providing a control signal to the vehicle drive device 600 on the basis of a signal provided by an external device.

The navigation system 770 may provide navigation information. The navigation information may include at least one of the following: map information, information on a set destination, information on a route to the set destination, information on various objects along the route, lane information, and information on the current location of a vehicle.

The navigation system 770 may include a memory and a processor. The memory may store navigation information. The processor may control the operation of the navigation system 770.

In some implementations, the navigation system 770 may update pre-stored information by receiving information from an external device through the communication device 400. In some implementations, the navigation system 770 may be classified as an element of the user interface device 200.

The sensing unit 120 may sense the state of the vehicle. The sensing unit 120 may include an attitude sensor (for example, a yaw sensor, a roll sensor, or a pitch sensor), a collision sensor, a wheel sensor, a speed sensor, a gradient sensor, a weight sensor, a heading sensor, a yaw sensor, a gyro sensor, a location module, a vehicle forward/reverse movement sensor, a battery sensor, a fuel sensor, a tire sensor, a steering sensor on the basis of the rotation of the steering wheel, an in-vehicle temperature sensor, an in-vehicle humidity sensor, an ultrasonic sensor, an illumination sensor, an accelerator pedal location sensor, and a brake pedal location sensor.

The sensing unit 120 may acquire sensing signals with regard to, for example, vehicle attitude information, vehicle collision information, vehicle driving direction information, vehicle location information (GPS information), vehicle angle information, vehicle speed information, vehicle acceleration information, vehicle tilt information, vehicle forward/reverse movement information, battery information, fuel information, tire information, vehicle lamp information, in-vehicle temperature information, in-vehicle humidity information, steering-wheel rotation angle information, out-of-vehicle illumination information, information about the pressure applied to an accelerator pedal, and information about the pressure applied to a brake pedal. The information acquired by the sensing unit 120 may be included in vehicle traveling information.

The sensing unit 120 may further include, for example, an accelerator pedal sensor, a pressure sensor, an engine speed sensor, an Air Flow-rate Sensor (AFS), an Air Temperature Sensor (ATS), a Water Temperature Sensor (WTS), a Throttle Location Sensor (TPS), a Top Dead Center (TDC) sensor, and a Crank Angle Sensor (CAS).

The interface 130 may serve as a passage for various kinds of external devices that are connected to the vehicle 100. For example, the interface 130 may have a port that is connectable to a mobile terminal and may be connected to the mobile terminal via the port. In this case, the interface 130 may exchange data with the mobile terminal.

In some implementations, the interface 130 may serve as a passage for the supply of electrical energy to a mobile terminal connected thereto. When the mobile terminal is electrically connected to the interface 130, the interface 130 may provide electrical energy, supplied from the power supply unit 190, to the mobile terminal under control of the controller 170.

The memory 140 is electrically connected to the controller 170. The memory 140 may store basic data for each unit, control data for the operational control of each unit, and input/output data. The memory 140 may be any of various hardware storage devices, such as a ROM, a RAM, an EPROM, a flash drive, and a hard drive. The memory 140 may store various data for the overall operation of the vehicle 100, such as programs for the processing or control of the controller 170.

In some implementations, the memory 140 may be integrally formed with the controller 170, or may be provided as an element of the controller 170.

The controller 170 may control overall operation of each unit in the vehicle 100. The controller 170 may be referred to as an Electronic Controller (ECU). The controller may control the vehicle 100 on the basis of navigation information provided by the navigation system 770 and information provided by the object detection device 300 or the communication device 400. Accordingly, the vehicle 100 may autonomously drive under the control of the controller 170.

At least one processor and the controller 170 included in the vehicle 100 may be implemented using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electric units for the implementation of other functions.

The power supply unit 190 may receive power from a battery inside the vehicle. The power supply unit 190 may supply the components with power necessary for operations of the respective components under the control of the controller 170.

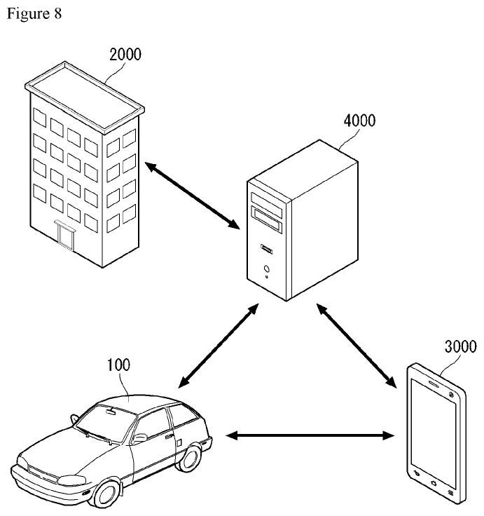

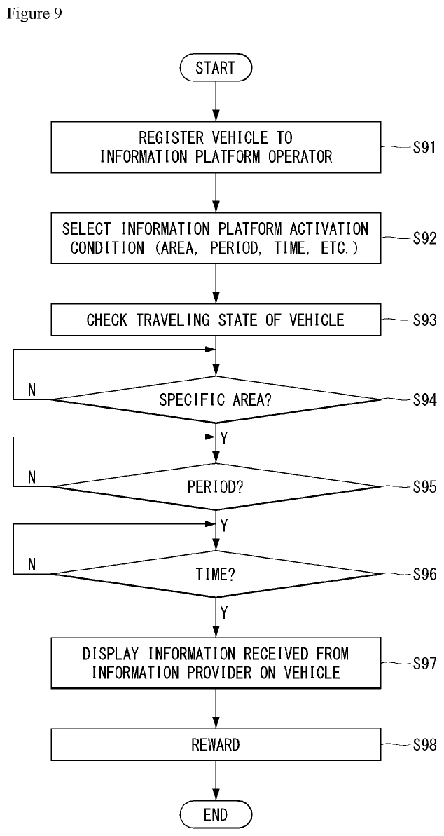

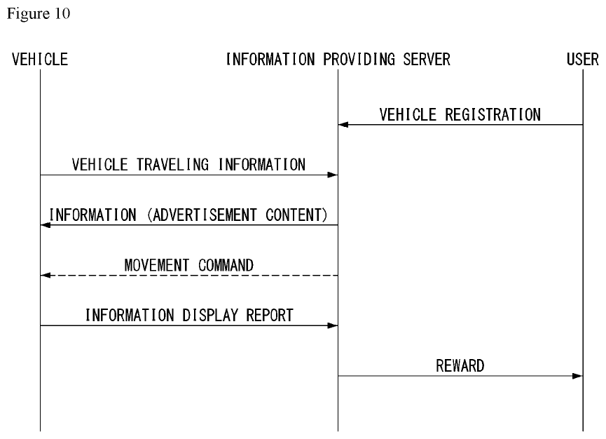

FIG. 8 is a diagram showing an information display system using a vehicle according to an embodiment of the present invention. FIGS. 9 and 10 are views showing a control procedure of an information display method according to an embodiment of the present invention.

Referring to FIG. 8, the information display system of the present invention includes an information providing server 4000 and a vehicle 100.

The information providing server 4000 receives registration of the vehicle from a user 3000 and transmits information requested by a client 2000 to the registered vehicle 100. The user 3000 may be an owner of the vehicle agreed to be used as an information platform. The client 2000 may be a public office or an advertiser who wants to use the registered vehicle 100 as an information platform through an information platform operator.

Here, the user 3000 may refer to a user terminal that may be connected to the information providing server 3000 and the vehicle 100 via a communication network. The user terminal may be a mobile terminal or a stationary terminal (computer).

The information may include various information such as living information, local information, public information, weather, emergency alert, advertisement information, and the like. The vehicle registered in the information providing server 4000 is utilized as an information platform during a schedule (area, period, or time) selected by the user. When an advertisement is displayed on the vehicle 100, the vehicle is used as an advertisement platform during a schedule selected by the user.

The information platform used in the present invention means a base for displaying an image or text including information by using the display of the vehicle 100. The advertisement platform refers to a platform for displaying an image or text including advertisement content using a display of the vehicle 100.

The user 3000 registers his or her vehicle to be utilized as an information platform online or offline to the information providing server 4000 and selects an information platform activation condition. The information platform activation condition includes an area, period, time, and the like for displaying information received from the information providing server 4000. For example, the user 3000 may select a specific area in which the vehicle 100 is to be utilized as an information platform as a parking area where the user himself or herself is mainly parked or an advertisement exposure area designated by a client. The period may be selected from the 1st to 20th of each month or from Monday to Friday, for example. Time may be selected from 9:00 am to 12:00 pm, 7:00 pm to 9:00 pm.

The information providing server 4000 rewards the user 3000 for using the information platform according to a predetermined reward policy. Reward may be a reward amount or points for the cost of purchasing goods or services.

The vehicle 100 includes the communication device 400 transmitting vehicle traveling information to the information providing server 4000 and receiving information or commands received from the information providing server 4000 and an output unit 250 supplying the information provided from the information providing server 4000 through the communication device 400 to one or more displays 251c and 251h whose screens are exposed to the outside to display the information on the displays 251c and 251h. The vehicle traveling information includes information about a location of the vehicle 100, a posture of the vehicle 100, and surrounding objects and geographical features.

Referring to FIGS. 9 and 10, the user 3000 registers his/her own vehicle to be used as an information platform to the information providing server 4000 (S91). The user 3000 selects an information platform activation condition such as an area, a period, a time, and the like and provides the selected information platform activation condition to the information providing server 4000 (S92).

The vehicle 100 registered as the information platform provides the vehicle traveling information to the information providing server 4000 in real time. The information providing server 4000 determines a current location and a posture of the vehicle 100, surrounding geographical features, a traveling state of the vehicle 100, and the like on the basis of the vehicle traveling information received in real time (S93).

When the information platform activation condition is met, the vehicle 100 displays the information provided from the information providing server 4000 on window side displays 251c and 251h on which a screen is externally visible (S94 to S97).

The vehicle 100 may determine whether to activate the information platform by checking a remaining battery capacity. Further, the information providing server 4000 may determine whether to activate the information platform by checking a remaining battery capacity of the vehicle 100 on the basis of vehicle state information received from the vehicle 100. The vehicle 100 or the information providing server 4000 may output an output available time of the information (advertisement) according to the remaining battery capacity to the user 3000 through the output unit 250 of the vehicle 100 or the mobile terminal of the user 3000 and guide the user to select whether to output.

The vehicle 100 or the information providing server 4000 may display information (advertisement) on the window of the vehicle 100 without any separate notification when charging cable connection is detected as the vehicle 100 is parked. When the remaining battery capacity of the vehicle 100 falls below a predetermined reference charge capacity, the vehicle 100 or the information providing server 4000 may stop outputting the information (advertisement) and informs the user about the remaining battery capacity and the information output stop situation through the mobile terminal of the user 3000.

The information providing server 4000 determines a current location, a traveling state, and the like of the vehicle 100 on the basis of the vehicle traveling information. As a result, when it is determined that the vehicle 100 is not present in a specific area previously designated by the user during the selected period and time, the information providing server 4000 may transmit a movement command instructing the vehicle 100 to move to the specific area. When the user 3000 gets in the vehicle 100 and the vehicle 100 is operated in the manual mode, the vehicle 100 guides the user 3000 to move to the specific area through the output unit 250. Here, a message for guiding the vehicle 100 to move to the specific area may be displayed on an internal display of the vehicle 100 and a voice guidance may be output through a speaker. If the vehicle 100 is an autonomous vehicle and the user 3000 is not present in the vehicle 100, the vehicle 100 moves to the specific area.

After the vehicle 100 operates as an information platform and displays information, the vehicle 100 may transmit an information display result report to the information providing server 4000. The information providing server 4000 updates the information platform utilization history of each vehicle on the basis of the information display result report received from the vehicle 100 and collects the reward amount/points on the basis of the information display result report received from the vehicle 100. The information providing server 4000 may transmit an information platform utilization status and a corresponding reward amount/point to the mobile terminal of the user 3000 (S98).

Hereinafter, an example in which the vehicle 100 operates as an advertisement platform will be described.

The vehicle 100 may select the displays 251c and 251h for displaying an advertisement on the basis of at least one of a direction of the screens of the displays 251c and 251h, the surrounding geographical features of the vehicle, and visibility of information according to an advertisement display location of the vehicle 100. The information providing server 4000 may select a window for displaying advertisement content on the basis of the vehicle traveling information received from the vehicle.

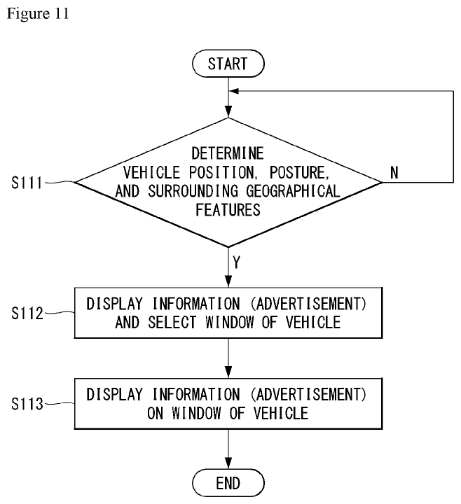

FIG. 11 is a flowchart illustrating a method of selecting a window of a vehicle utilized as an information platform in an information display method according to an embodiment of the present invention.

Referring to FIG. 11, in the information display method, a location of the vehicle, a posture of the vehicle, and surrounding geographical features are determined on the basis of the vehicle traveling information (S11).

In the information display method, a window of the vehicle on which information (advertisement) is to be displayed is selected on the basis of at least one of the direction of the screen of the display disposed in the windows, surrounding geographical features of the vehicle 100, and visibility of the information, and an image or text including information (advertisement) is displayed on the selected window (S112 and S113)

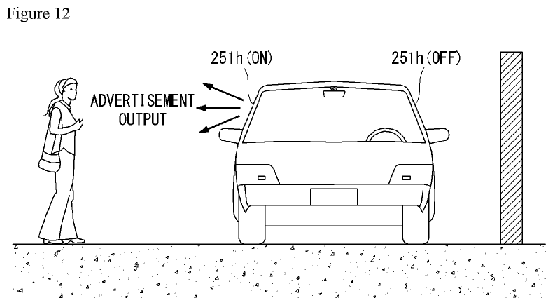

For example, when the vehicle 100 is parked next to a wall surface of a building as shown in FIG. 12, it is not necessary to display the advertisement on the display 251h (OFF) of the window facing the wall. In this case, the vehicle 100 drives only the display 251h (ON) of the window exposed to the people without driving the display 251h (OFF) facing the wall surface and displays the advertisement on the display 251h (ON). The vehicle 100 or the information providing server 4000 may select a window in which the advertisement content is to be displayed under the control of the information providing server 4000.

An example of a method of selecting a window of the vehicle 100 in consideration of visibility of the advertisement according to the advertisement display location of the vehicle 100 is as follows. Although the display disposed on the window of the passenger's seat may be selected according to a result of selecting the display on the basis of the direction of the screen of the display and the surrounding geographical features, if it is determined that visibility or an advertisement effect of the advertisement content is greater when the advertisement is displayed on the window of the driver's seat, the display disposed at the window of the driver's seat may be finally selected.

When the advertisement platform is activated and the advertisement is displayed on the display of the vehicle 100, it is necessary to consider the effect of the advertisement exposure and safety of the occupant and a nearby pedestrian.

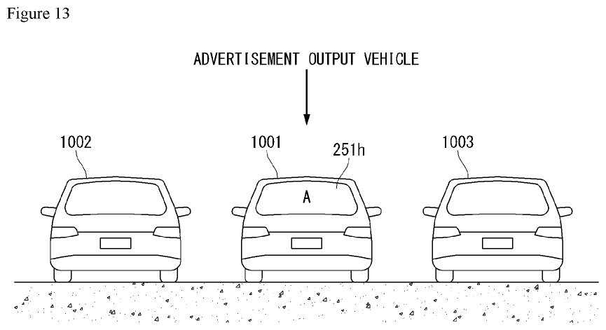

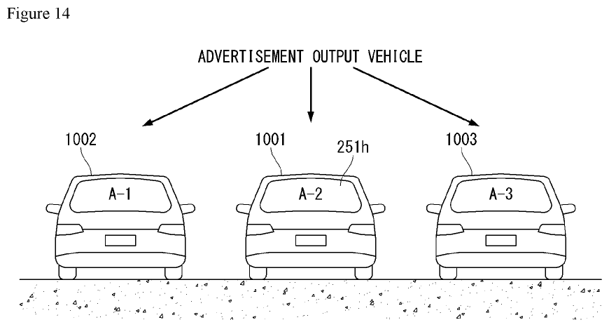

FIGS. 13 and 14 are views showing an example in which an advertisement is displayed on one or more vehicles in a situation where a plurality of vehicles are parked next to each other.

Referring to FIGS. 13 and 14, when vehicles 1002 and 1003 are parked on the left and right sides of a vehicle 1001 registered as an advertisement platform, a side window of the vehicle 1001 is not visible. In consideration of this, the advertisement content A may be displayed on a rear window 251h of the vehicle 1001.

If the neighboring vehicles 1001, 1002 and 1003 are advertisement platform registered vehicles, advertisement content A-1, A-2, and A-3 may be displayed on the windows of the vehicles 1001, 1002 and 1003. In this case, the advertisement content image may be divided and the image may be displayed to be larger on the windows of the vehicles 1001, 1002, and 1003 and more information may be displayed. The advertisement may be output after the advertisement output is approved by the owners of the vehicles 1001, 1002, and 1003. Since the vehicles 1001, 1002, and 1003 are registered in the information providing server 3000, the neighboring vehicles 1001, 1002, and 1003 may be used as advertisement platforms without any separate permission from the vehicle owners.

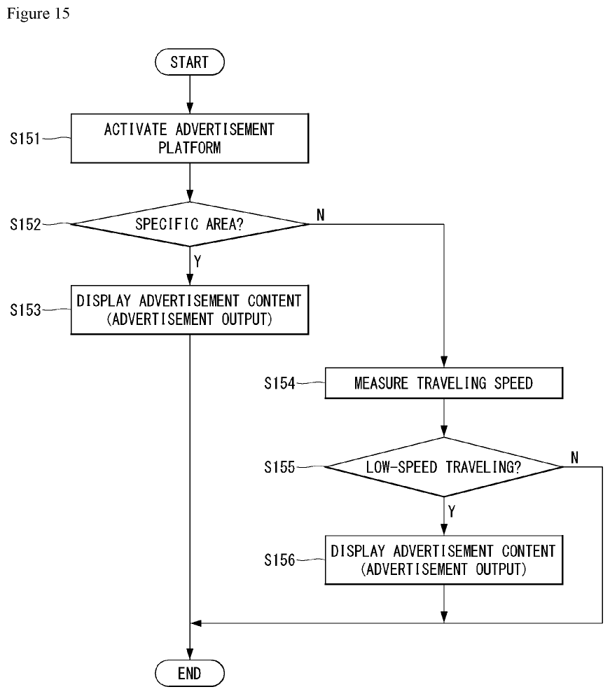

Referring to FIG. 15, if the vehicle is parked or stopped when the advertisement platform is activated, the advertisement content received from the information providing server 4000 is displayed on the window of the vehicle 100 (S151 to S153).

If the vehicle 100 is traveling, the vehicle 100 or the information providing server 4000 measures a traveling speed of the vehicle 100 and displays the advertisement content on the display of the vehicle 100 when the vehicle 100 travels at a low speed equal to or lower than a predetermined low speed reference speed (S154 to S156). When the vehicle 100 is traveling at a high speed, surrounding objects may not be visible due to the advertisement content displayed on the display of the window, and thus, the occupant and a nearby pedestrian may be in a dangerous situation.

The vehicle 100 or the information providing server 4000 may determine whether to display the advertisement content on the basis of a possibility of movement in consideration of a current destination of the vehicle 100. When the information platform activation condition is set, the area where the advertisement content is displayed may be set to a range within a radius of 1 km from a specific point. When the current location of the vehicle is set to be within the range of the specific area, the controller 170 of the vehicle 100 or the information providing server 4000 may control the display of the vehicle 100 to display the advertisement content on the window of the vehicle 100 when the vehicle 100 enters the range of the specific area.

For example, the specific area in which the advertisement content is to be output may be set to a range within a radius of 1 km from exit No. 1 of Myeongdong station. An advertisement may be output to the window of the vehicle from the moment when the vehicle 100 enters the specific area as shown in FIG. 16. Here, if the vehicle 100 is traveling at a low speed, the advertisement may be displayed on the window of the back seat because displaying of the advertisement on the windows of the driver's seat and the passenger's seat and the front and rear windows may incur a risk. If the vehicle 100 is parked or stopped in a particular area, advertisements may be displayed on the windows of the driver's seat and the passenger's seat and the front and rear windows.

The advertisement displayed on vehicle in the specific area may vary according to locations. For example, a movie related advertisement may be displayed on the window of the vehicle 100 in front of a movie theater in the specific area, and a cosmetic advertisement may be displayed on the window of the vehicle 100 in front of the cosmetic shop.

If the current destination of the vehicle 100 is outside the area where the advertisement platform is activated, the controller 170 of the vehicle 100 or the information providing server 4000 may monitor the traveling state of the vehicle 100 and determine activation of the advertisement platform.

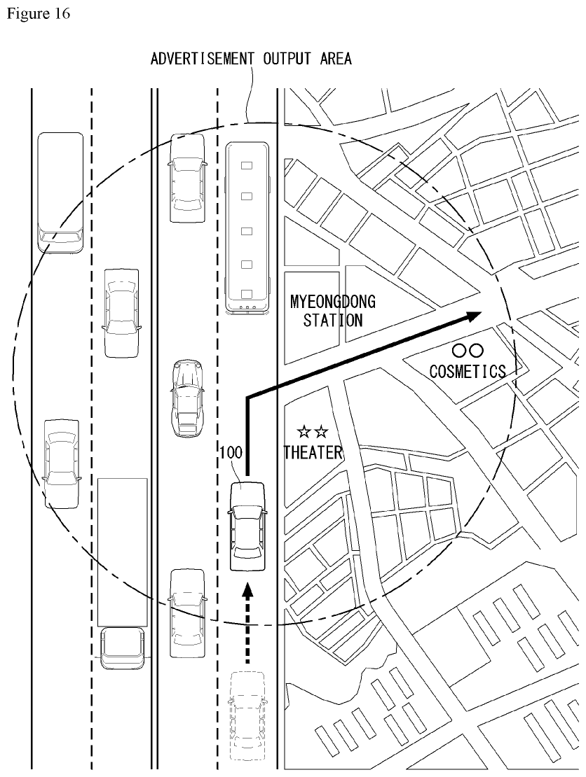

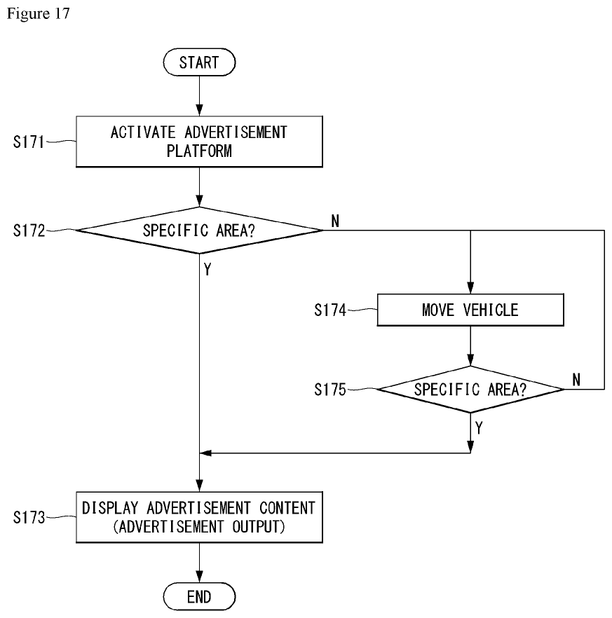

If the vehicle 100 is not located in the specific area previously set by the user 3000 when the advertisement platform is activated, the vehicle 100 may be controlled to the autonomous driving mode, moved to the specific area to display the information, and then return to an original position thereof as illustrated in FIG. 17.

Referring to FIG. 17, if the vehicle 100 is in the specific area where the advertisement content is displayed when the advertisement platform is activated, the vehicle 100 displays the advertisement content received from the information providing server 4000 on the window of the vehicle 100 (S171 to S173).

If the vehicle 100 is not located in the specific area where the advertisement content is to be displayed when the platform is activated, the information providing server 4000 transmits a movement command 2 together with location information of the specific area to the vehicle 100. If the vehicle 100 is traveling under the control of the driver in the manual mode, the driver may be guided to move to the specific area. If the vehicle 100 is in the autonomous driving mode, the vehicle 100 sets specific information as a destination, moves to the specific information, displays information on the window for a preset time, and then returns to an original position thereof (S173 to S175).

The information providing server 4000 may switch the vehicle 100 to the autonomous driving mode so that the vehicle 100 may be moved to the specific area.

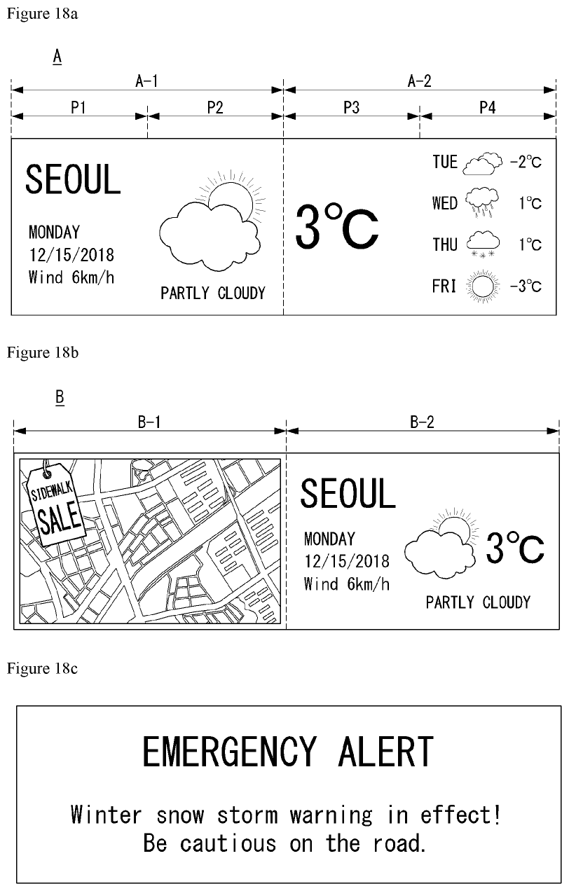

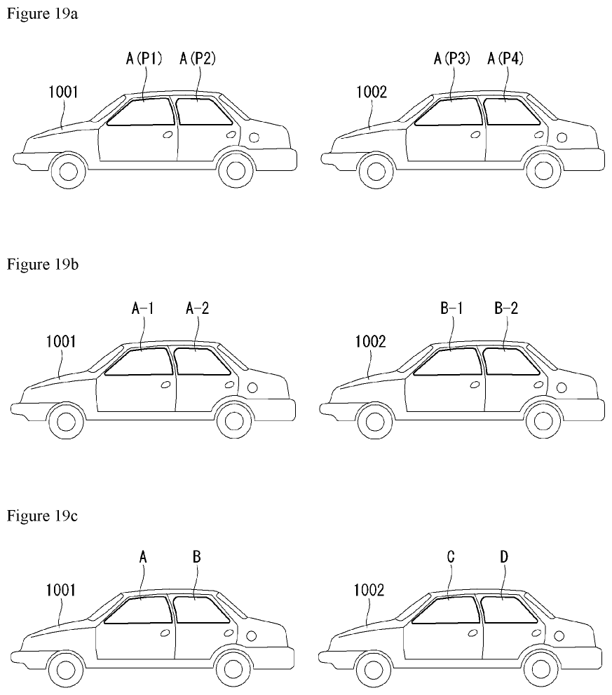

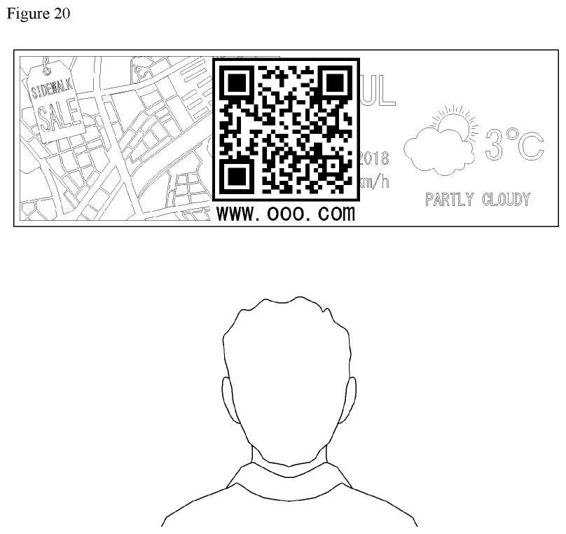

FIGS. 18A to 18C are views showing various examples of information displayed on a window of a vehicle. FIG. 19A to 19C are views showing various examples of a method of displaying information on a window of a vehicle when the vehicle operates as an information platform.

The information to be displayed on the window of the vehicle 100 may include living information, local information, public information, and weather information as shown in FIG. 18A. Further, the information may include various information such as advertisement information as shown in FIG. 18B or an emergency alert as shown in FIG. 18C.

Information may be displayed on one or more vehicles 100. For example, as shown in FIG. 19A, an information image A may be divided into four parts (P1 to P4) and separately displayed on the first and second vehicles 1001 and 1002). As illustrated in FIG. 19B, the information image A may be divided into two parts A-1 and A-2 and separately displayed in the first and second windows of the first vehicle 1001, and information image B may be divided into two parts B-1 and B-2 and separately displayed in the first and second windows of the second vehicle 1002. As illustrated in FIG. 19C, mutually independent whole information images A to D may be displayed separately on the windows of the first and second vehicles 1001 and 1002.

When a person approaches the vehicle operating as an advertisement platform, advertisement article-related information may be magnified and displayed in an advertisement content image (FIG. 18B) displayed on the window of the vehicle 100. The advertisement article-related information may be detailed product information, a URL address, a QR code, and the like.

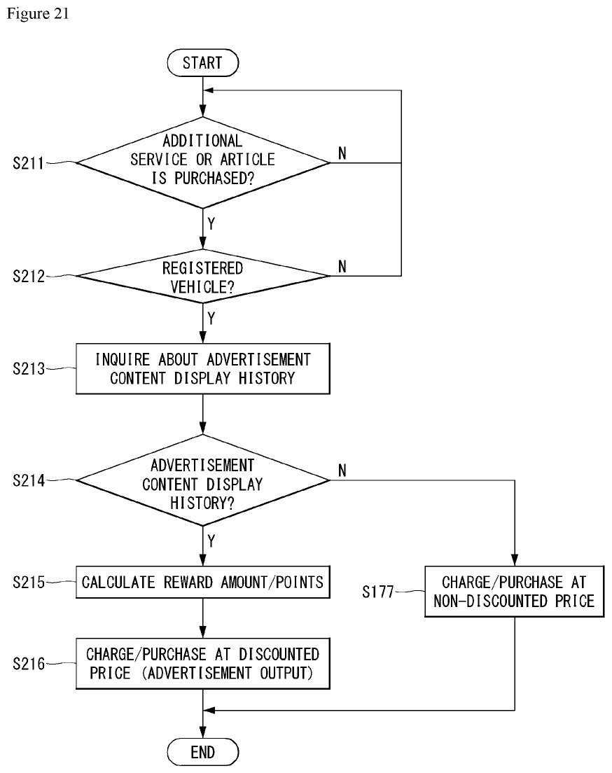

FIG. 21 is a flowchart showing an example of a method for rewarding a vehicle for utilization thereof as an advertisement platform. This rewarding method is based on the assumption that the user 3000 agrees to utilize his/her vehicle as an advertisement platform.

Referring to FIG. 21, when the user 3000 purchases an additional service or an article provided by an affiliate of an information provider (S211), the user may get a discount on a purchase cost as a reward provided by the information provider. The additional service may be a parking service, a shared vehicle service, or the like.

The information providing server 4000 operated by the information provider checks whether the vehicle 100 is a vehicle registered to an advertisement platform service (S212) and inquires for advertisement content display history of the vehicle 100 (S213). The advertisement content display history may be history of displaying other information such as local information, emergency alert, and the like.

The information providing server 4000 calculates a reward amount or points on the basis of the advertisement content display history of the vehicle 100 and transmits the calculated reward amount or point to the user 3000 (S214 and S215). The user 3000 may purchase the additional service or the article at a discounted price corresponding to the amount of reward/points according to the provision of the advertisement platform (S216).

If there is no advertisement content display history related to the vehicle 100 in step S214, the information providing server 4000 transmits a corresponding result to the user 3000. In this case, the user 3000 may purchase the additional service or the article at a non-discounted price (S177).

An information display method and system using a vehicle according to an embodiment of the present invention may be described as follows.

An information display method using a vehicle according to an embodiment of the present invention includes: transmitting vehicle traveling information indicating a location of a vehicle 100, a posture of the vehicle, and surrounding geographical features to an external information providing server 4000; and supplying the information provided from the information providing server to at least one display with an externally exposed screen to display the information on the display. Display of a window on which the information is to be displayed is selected from windows of the vehicle on the basis of at least one of a direction in which a screen of the display faces, surrounding geographical features of the vehicle, and visibility of information according to a position of the display.

The information includes at least one of living information, local information, public information, weather, emergency alert, and advertisement information.

The information may be displayed on the window of the vehicle when the vehicle is in a parked or stopped state or when the vehicle 100 is traveling at a low speed lower than a predetermined reference speed.

The information display method further includes: registering the vehicle 100 as a vehicle utilized as an information platform; and setting an information platform activation condition including a specific area where the information is to be displayed, a period during which the information is to be displayed, and a time at which the information is to be displayed. The information is displayed on the window of the vehicle when the information platform activation condition is met.

The information display method further includes: if a current destination of the vehicle is outside the specific area, determining whether to display the advertisement content on the vehicle by determining a possibility of further movement of the vehicle.

The information display method further includes: if the vehicle 100 is not located in the specific area during the period and time set in the information platform activation condition, transmitting, by the information providing server 4000, a movement command instructing to move to the specific area to the vehicle 100; and allowing the vehicle 100 to move to the specific area in response to the movement command, display the information on the window, and return to an original position thereof of the vehicle 100.

In response to the movement command, the vehicle 100 autonomously drives to move to the specific area and subsequently returns to an original position thereof.

The information display method further includes: if the movement command is received by the vehicle when the vehicle is in the manual mode, displaying a message indicating to move to the specific area on an internal display of the vehicle 100.

The information display method further includes: dividing an image of the information into parts and displaying the divided parts on the windows of the vehicle 100.

The information display method further includes: dividing an image of the information into parts and displaying the divided parts on windows of at least two vehicles 1001 and 1002.

The information display method further includes: displaying information related to an advertisement product in a magnified manner in an advertisement content image displayed on the window of the vehicle when a person approaches the vehicle 100. The information related to the advertisement product includes at least one of detailed information, a URL address, and a QR code of the advertisement product.

The information display method further includes: calculating, by the information providing server 4000, a reward amount or points according to information display history of the vehicle. An additional service or an article is purchased at a price discounted as much as the reward amount or a reserved point amount.

An information display apparatus using a vehicle according to an embodiment of the present invention includes: an information providing server 4000 receiving vehicle traveling information indicating a location of a vehicle, a posture of the vehicle, and surrounding geographical features and transmitting the information to the vehicle, and a controller 170 of the vehicle 100 supplying the information provided from the information providing server to at least one display with an externally exposed screen to display the information on the display. Display of a window on which the information is to be displayed is selected from windows of the vehicle on the basis of at least one of a direction in which a screen of the display faces, surrounding geographical features of the vehicle, and visibility of information according to a position of the display.

The information includes at least one of living information, local information, public information, weather, emergency alert, and advertisement information.

The information is displayed on the window of the vehicle when the vehicle is in a parked or stopped state or when the vehicle is traveling at a low speed lower than a predetermined reference speed.

The vehicle is registered as a vehicle utilized as an information platform to the information providing server with the consent of the user 3000. An information platform activation condition including a specific area where the information is to be displayed, a period during which the information is to be displayed, and a time at which the information is to be displayed is set in the information providing server 4000 with the consent of the user. The information is displayed on the window of the vehicle when the information platform activation condition is met.

If a current destination of the vehicle is outside the specific area, the information providing server 4000 or the controller 170 of the vehicle determines whether to display the advertisement content on the vehicle by determining a possibility of further movement of the vehicle.

In response to a movement command received from the information providing server, the vehicle 1000 travels in an autonomous driving mode to move to the specific area under the control of the information providing server 4000 or the controller 170 of the vehicle.

The information providing server 4000 or the controller 170 of the vehicle controls the vehicle 100 in an autonomous driving mode to display the information on the window for a predetermined period of time, autonomously drives the vehicle to move to the specific area in response to the movement command, and subsequently returns the vehicle to an original position thereof.

If the movement command is received by the vehicle when the vehicle is in the manual mode, the information providing server 4000 or the controller 170 of the vehicle displays a message indicating to move to the specific area on an internal display of the vehicle.

The information providing server 4000 or the controller 170 of the vehicle divides an image of the information into parts and displays the divided parts on a plurality of windows.

The information providing server 4000 or the controller 170 of the vehicle divides an image of the information into parts and displays the divided parts on windows of two or more vehicles.

The information providing server 4000 or the controller 170 of the vehicle displays information related to an advertisement product in a magnified manner in an advertisement content image displayed on the window of the vehicle when a person approaches the vehicle. The information related to the advertisement product includes at least one of detailed information, a URL address, and a QR code of the advertisement product.

The information providing server 4000 generates a reward amount or a reserved point amount on the basis of information display history of the vehicle 100. The information providing server 4000 may apply the reward amount or the reserved point amount as a discount amount of an additional service or an amount of purchasing an article.

The vehicle control apparatus of the present invention includes: a communication device 400 transmitting vehicle traveling information indicating a location of a vehicle, a posture of the vehicle, and surrounding geographical features to an external information providing server; and an output device 250 supplying the information provided from the information providing server to at least one display with an externally exposed screen through the communication device to display the information on the display. Display of a window on which the information is to be displayed is selected from windows of the vehicle 100 on the basis of at least one of a direction in which a screen of the display faces, surrounding geographical features of the vehicle 100, and visibility of information according to a position of the display.

The information display system using a vehicle according to an embodiment of the present invention includes: a vehicle 100 registered as a vehicle consented to utilization as an information platform; and an information providing server 4000 receiving vehicle traveling information indicating a location of the vehicle, a posture of the vehicle, and surrounding geographical features from the vehicle and transmitting information to be output on a display disposed on a window of the vehicle to the vehicle. Display of a window on which the information is to be displayed is selected from windows of the vehicle on the basis of at least one of a direction in which a screen of the display faces, surrounding geographical features of the vehicle 100, and visibility of information according to a position of the display.

An advertisement content providing method through a vehicle window according to an embodiment of the present invention includes: checking a traveling state of a vehicle; receiving advertisement content including traveling state information related to the traveling state; and providing the received advertisement content to at least one of windows of the vehicle, wherein a window for outputting the advertisement content may be selected on the basis of at least one of a direction in which the window of the vehicle faces, information related to surrounding geographical features, and visibility of advertisement content provided through a specific window of the windows of the vehicle.

The present disclosure described above may be implemented as a computer-readable code in a medium in which a program is recorded. The computer-readable medium includes any type of recording device in which data that can be read by a computer system is stored. Also, the computer may include the controller 180 of the terminal. Thus, the foregoing detailed description should not be interpreted limitedly in every aspect and should be considered to be illustrative. The scope of the present invention should be determined by reasonable interpretations of the attached claims and every modification within the equivalent range are included in the scope of the present invention.

The information display method, vehicle and system using the vehicle according to the above-described embodiment can improve the convenience of an occupant. It can be used during autonomous or semi-autonomous driving of the vehicle according to the above-described embodiment.

The features, structures, effects, and the like described in the above-described embodiments include at least one embodiment of the present invention, but the present invention is not limited only to one embodiment. Further, the features, structures, effects, and the like illustrated in each embodiment may be combined or modified to other embodiments by those skilled in the art. Therefore, content related to the combination or the modification should be interpreted to be included in the scope of the invention.

In addition, while the present invention has been particularly described with reference to exemplary embodiments, the present invention is not limited thereto. It will be understood by those skilled in the art that various modifications and applications, which are not illustrated in the above, may be made without departing from the spirit and scope of the present invention. For example, each component illustrated in the embodiments may be modified and made. It should be interpreted that differences related to these modifications and applications are included in the scope of the invention defined in the appended claims.

1. An information display method comprising:
determining vehicle traveling information that indicates a location of a vehicle, a posture of the vehicle, and surrounding geographical features at the location of the vehicle;
transmitting, to an external information providing server, the vehicle traveling information;
receiving, from the external information providing server, display information selected based on the vehicle traveling information;
determining at least one of a direction in which a screen of at least one display faces, surrounding geographical features of the vehicle at the location of the vehicle when the display information is to be displayed, or visibility of information according to a position of the at least one display;
selecting, from among windows of the vehicle, a display of a window based on at least one of the direction in which the screen of at least one display faces, the surrounding geographical features of the vehicle at the location of the vehicle when the display information is to be displayed, and the visibility of information according to the position of the at least one display; and
supplying the display information received from the information providing server to the selected display of the window with an externally exposed screen to display the display information on the selected display of the window.

2. The information display method of claim 1, wherein:
the display information includes at least one of living information, local information, public information, weather information, emergency alert information, or advertisement information.

3. The information display method of claim 1, wherein:
the display information is displayed on the selected window of the vehicle based on the vehicle being in a parked or stopped state or based on the vehicle traveling at a speed that is lower than a predetermined reference speed.

4. The information display method of claim 3, further comprising:
registering the vehicle as a vehicle utilized as an information platform; and
setting an information platform activation condition for the vehicle, the information platform activation condition including a specific area where the display information is to be displayed, a period during which the display information is to be displayed, and a time at which the display information is to be displayed,
wherein the display information is displayed on the selected window of the vehicle based on the information platform activation condition being met.

5. The information display method of claim 4, further comprising:
based on a current destination of the vehicle being outside the specific area, determining whether to display the display information on the vehicle by determining a possibility of further movement of the vehicle to the specific area where the display information is to be displayed.

6. The information display method of claim 4, further comprising:
based on the vehicle being located outside of the specific area during the period and time set in the information platform activation condition, transmitting, by the information providing server, a movement command instructing movement of the vehicle to the specific area; and
allowing the vehicle to move to the specific area in response to the movement command, display the display information on the selected window, and return to an original position of the vehicle.

7. The information display method of claim 6, wherein:
in response to the movement command, the vehicle autonomously drives to the specific area and subsequently returns to an original position of the vehicle.

8. The information display method of claim 6, further comprising:
based on the movement command being received by the vehicle when the vehicle is in the manual mode, displaying, on an internal display of the vehicle, a message indicating that the vehicle should be moved to the specific area.

9. The information display method of claim 1, further comprising:
dividing an image of the display information into parts and displaying the divided parts on the windows of the vehicle.

10. The information display method of claim 1, further comprising:
dividing an image of the display information into parts and displaying the divided parts on windows of at least two vehicles.

11. The information display method of claim 1, further comprising:
displaying, in an advertisement content image displayed on the selected window of the vehicle, advertisement information related to an advertisement product in a magnified manner based on detection of a person approaching the vehicle,
wherein the advertisement information related to the advertisement product includes at least one of detailed information, a URL address, or a QR code of the advertisement product.

12. The information display method of claim 1, further comprising:
calculating, by the information providing server, a reward amount or points according to information display history of the vehicle,
wherein an additional service or an article is purchased at a price discounted as much as the reward amount or a reserved point amount.

13. An information display system comprising:
a vehicle control device of a vehicle; and
an information providing server that is external to the vehicle,
wherein the vehicle control device is configured to determine vehicle traveling information that indicates a location of the vehicle, a posture of the vehicle, and surrounding geographical features at the location of the vehicle and transmit, to the information providing server, the vehicle traveling information,
wherein the information providing server is configured to receive, from the vehicle control device, the vehicle traveling information, select display information for the vehicle based on the vehicle traveling information, and transmit, to the vehicle control device, the display information for the vehicle, and
wherein the vehicle control device is configured to:
receive, from the external information providing server, the display information,
determine at least one of a direction in which a screen of at least one display faces, surrounding geographical features of the vehicle at the location of the vehicle when the display information is to be displayed, or visibility of information according to a position of the at least one display,
select, from among windows of the vehicle, a display of a window based on at least one of the direction in which the screen of at least one display faces, the surrounding geographical features of the vehicle at the location of the vehicle when the display information is to be displayed, and the visibility of information according to the position of the at least one display, and
supply the display information received from the information providing server to the selected display of the window with an externally exposed screen to display the display information on the selected display of the window.

14. The information display system of claim 13, wherein:
the display information includes at least one of living information, local information, public information, weather information, emergency alert information, or advertisement information.

15. The information display system of claim 13, wherein:
the vehicle control device is configured to display the display information on the selected window of the vehicle based on the vehicle being in a parked or stopped state or based on the vehicle traveling at a speed lower than a predetermined reference speed.

16. The information display system of claim 15, wherein:
the vehicle is registered as a vehicle utilized as an information platform to the information providing server, and
the vehicle control device is configured to display the display information on the selected window of the vehicle based on an information platform activation condition being met, the information platform activation condition being set in the information providing server and including a specific area where the display information is to be displayed, a period during which the display information is to be displayed, and a time at which the display information is to be displayed.

17. The information display system of claim 16, wherein:
the information providing server or the vehicle control device is configured to, based on a current destination of the vehicle being outside the specific area, determine whether to display the display information on the vehicle by determining a possibility of further movement of the vehicle to the specific area.

18. The information display system of claim 16, wherein:
the vehicle control device is configured to, in response to a movement command received from the information providing server, control the vehicle to travel in an autonomous driving mode to the specific area.

19. The information display system of claim 18, wherein:
the vehicle control device is configured to control the vehicle in an autonomous driving mode to display the display information on the window for a predetermined period of time, autonomously drive to the specific area in response to the movement command, and subsequently return to an original position of the vehicle.

20. An information display system comprising:
a vehicle registered for use as an information platform; and
an information providing server that is external to the vehicle,
wherein the information providing server is configured to:
receive, from the vehicle, vehicle traveling information that indicates a location of the vehicle, a posture of the vehicle, and surrounding geographical features at the location of the vehicle,
select display information for the vehicle based on the vehicle traveling information, and
transmit, to the vehicle, the display information for the vehicle,
wherein a display of a window on which the display information is to be displayed is selected from windows of the vehicle based on at least one of a direction in which a screen of the display faces, surrounding geographical features of the vehicle at the location of the vehicle when the display information is to be displayed, and visibility of information according to a position of the display.
